(19) United States
(12) Patent Application Publication
(10) Pub. No.: US 2016/0190680 A1
(43) Pub. Date: Jun. 30, 2016

(54) Signal shield dish cover

(71) Applicant: Randall Lige Phipps, Lucasville, OH (US)

(72) Inventor: Randall Lige Phipps, Lucasville, OH (US)

(21) Appl. No.: 14/544,351

(22) Filed: Dec. 29, 2014

(51) Int. Cl. H01Q 1/42; H01Q 15/16

(52) U.S. Cl. CPC H01Q 1/421; H01Q 15/16

(57) ABSTRACT

A method of using a cover on a satellite receiving dish to prevent the building up of snow, rain or ice on the reflective dish or on the receiving eye of a parabolic dish antenna to prevent the scrambling of the signal being received or transmitted, with the cover having a unique shape that allows it to cover both the reflective dish and the receiving eye while leaving an opening in the center therefore allowing an unimpeded clear signal to be received by the dish in bad weather.

### CROSS-REFERENCE TO RELATED APPLICATIONS

US Patent Documents

| Provisional 61/998,654 | Jul. 2014 | Phipps |
|---|---|---|
| 7,339,547 | Mar. 2008 | Reid Jr. |
| 6,072,440 | Jun. 2000 | Bowman |
| 5,815,125 | Sep. 1998 | Kelly |
| D446206 | Aug. 2001 | Hochendoner |
| 7,277,064 | Oct. 2007 | Hogsett |
| 6,714,167 | Mar. 2004 | Gusick Jr. |

### STATEMENT REGARDING FEDERALLY SPONSORED RESEARCH OR DEVELOPMENT

“Not Applicable”

### REFERENCE TO SEQUENCE LISTING, A TABLE, OR A COMPUTER PROGRAM LISTING COMPACT DISC APPENDIX

“Not Applicable”

### BACKGROUND OF THE INVENTION

1. Field of the Invention
1. The present invention relates to parabolic satellite antenna cover in the present form comprised of two parts and more particularly pertains to a “parabolic dish shield” (1) having a certain ornamental design which incorporates a second part “receiving eye horn shield” (2) also having a certain ornamental design. the first part of the present invention being; the parabolic dish shield (1) being an arc shaped pliable plastic or polymer, (but not limited to these materials), having four or more C-shaped metal clips (1a), evenly spaced across the long edge of the arc, as to secure the shield to the rim of the parabolic dish thus forming a partial roof over the parabolic dish, without having to permanently alter the parabolic dish.
2. The second part of the present invention being, the “receiving eye horn shield” (2) having a certain ornamental design, comprising; a pliable plastic or polymer, (but not limited to these materials), arc shaped top having the two ends at a ninety degree angle of the top arc (2b), further more having adhesive backed Velcro strips (2a) placed on the top arc and the two ends, part (2) of the present invention also incorporates a plastic zip tie (2c), as to attach the shield to the horn without having to permanently alter the receiving eye horn.
3. The unique shape of the “parabolic dish shield” part (1) of the present invention when coupled with the new and unique shape of the “receiving eye horn shield” part (2) of the present invention act as a roof over the dish and the eye horn preventing rain, snow, and ice from diminishing the signal and causing signal lose. The unique shape of part (1) and (2) of the present invention, the two parts of the present invention are sized in such a way as to allow a large open space between the two parts which enables the parabolic satellite antenna/dish to continue to receive a signal even when rain, ice, or snow have built up on the shield.
4. Even though the present invention is represented as two parts it may also be formed as one piece which also incorporates all of the aspects of the present invention that are new to the art.

2. Description of the Prior Art

The use of parabolic dish cover devices of known designs and configurations is known in the prior art. More specifically, by way of example; Reid Jr. U.S. Pat. No. 7,339,547 discloses a cover that completely covers only the concave or reflective side of the parabolic dish, Bowman U.S. Pat. No. 6,072,440 discloses a receiving eye feed horn cover only, made of a ridged material being permanently fastened to the receiving eye horn, Kelly U.S. Pat. No. 5,815,125 discloses a cover that completely covers the dish, dish mount bracket, receiving eye horn, and receiving eye horn bracket, incorporating a cinching mechanism for affix the cover to the dish, Hochendoner U.S. Pat. No. D446,206 discloses a cover having a completely different ornamental design, Hogsett U.S. Pat. No. 7,277,064 discloses a cover completely covering the concave side of the parabolic dish having magnets to attach it to the dish, Gusick Jr. U.S. Pat. No. 6,714,167 discloses a cover made of fabric having a draw string to secure it to the dish.

While these devices fulfill their respective, particular objectives and requirements, the aforementioned patents do not describe a parabolic dish cover/shield that acts like a roof having a certain design that prevents rain, snow, and ice from building up on the reflective side of the parabolic dish, the receiving eye and the cover itself, while also allowing the unimpeded reception of the signal thru an open area between the two parts of the present invention, without making permanent alterations to the parabolic dish or receiving eye horn. According to the unique construction and design the present invention substantially parts from the conventional concepts and designs of the prior art and in doing so provides an apparatus primarily developed for the purpose of preventing signal lose in bad weather conditions without making permanent alterations to the dish or eye horn.

Therefore, it can be appreciated that there exist a continuing need for a new and improved dish cover/shield that allows for unimpeded reception of the satellite dish signal in bad weather conditions without permanent alterations to the parabolic antenna. In this regard, the present invention substantially fulfills this need.

### BRIEF SUMMARY OF THE INVENTION

In view of the foregoing disadvantages inherent to the known types of parabolic dish covers of known design and configurations now present in the prior art, the present invention provides an improved system for preventing diminished signal strength during bad weather. As such, the general purpose of this invention, which will be described subsequently in greater detail, is to provide a new and improved dish cover which has all the advantages of the prior art and none of the disadvantages.

To attain this, the present invention comprises, the first of two parts being an arc shaped parabolic dish cover approximately 40″×6″×0.020″ (1) constructed of, (but not limited to), pliable plastic or poly material having 4 C-shaped metal clips (1a) approximately ½″ wide evenly spaced along the long side of the arc thus allowing the cover to attach to the rim of the parabolic dish without making any permanent alterations to the parabolic dish. The second part of the present invention is a receiving eye horn cover (2) being an arc shaped pliable plastic or poly, (but not limited to these materials), varying in length being approximately 5″ wide and 0.020″ thick having two downward sides (2b) also having 3 adhesive backed Velcro strips (2a) along one end, which also incorporates a plastic zip tie (2c) for attaching the cover to the receiving eye horn without permanent alterations to the receiving eye horn. The two parts of the present invention are sized in such a way as two allow for a large opening between the two parts of the present invention thus allowing for unimpeded reception of the signal while providing protection from weather conditions such as rain, snow, or ice build up on the parabolic antenna/dish. This embodies the new and improved features, of the present invention. Although the present invention is represented as a two part system it may also be formed as one part embodying all the aspects of the present invention that are new to the art.

There has thus been outlined, rather broadly, the more important features of the invention in order that the detailed description thereof that follows may be better understood and in order that the present contribution to the art be better appreciated. There are, of course, additional features of the invention that will be described hereinafter and will help to form the subject matter of the Claims.

In this respect, before explaining at least one embodiment of the invention in detail, it is understood that the invention is not limited in its application to the details of construction and to the arrangements of the components set forth in the descriptions or illustrated in the drawings. The invention is capable of other embodiments and of being practiced and carried out in various ways. Also, it is understood that the phraseology and terminology employed herein are for the purpose of description and should not be regarded as limiting.

As such, those skilled in the art will appreciate that the conception, upon which this discloser is based, may readily be utilized as a basis for designing of other structures, methods and systems for carrying out the several purposes of the present invention. It is important, therefore, that the claims be regarded as including such equivalent constructions insofar, as they do not depart from the spirit and scope of the present invention.

It is therefore an object of the present invention to provide a new improved parabolic satellite dish and receiving eye horn cover, having all the advantages of the prior art dish covers of known designs and configurations and none of the disadvantages.

It is another object of the present invention to provide a pliable durable construction to be easily and inexpensively manufactured.

It is another object of the present invention to provide a shield/roof (1) extending outward from the concave main body or reflective dish of the parabolic antenna toward the receiving eye horn a short distance thus forming a roof over only the main concave body of the antenna and not the eye horn bracket or the eye horn.

An even further object of the present invention is to form a roof over the receiving eye or eyes (2) extending outward toward the main body of the parabolic antenna but not covering the eye horn bracket nor extending outward far enough to overlap the roof/shield of the main body, thus leaving an opening between the two roofs allowing for an unimpeded reception of the satellite signal. Thus differing from the other covers of known design to the prior art.

It is an even further object of the present invention to prevent rain, snow, and ice from building up on the reflective side of the main body and the receiving eye/eyes of the parabolic antenna. Thus preventing refraction or scrambling of the digital signal allowing for strong undiminished reception.

It is an even further object of the present invention to attach to the main body and the receiving eye/eyes of the parabolic antenna without permanently altering any part of the parabolic antenna, thru the use of the C-shaped metal clips (1a), Velcro strips (2a), and zip ties (2c).

The final object of the present invention is to allow the unimpeded reception of the signal when rain, snow, or ice, is on the roofs/shields thru the ornamental design by incorporating an opening between the two roofs/shields, also by incorporating open space between the reflective side main body and the receiving eye/eyes.

These together with other objects of the invention, along with various features of novelty which characterize the invention are pointed out with particularity in the claims annexed to and forming a part of this disclosure, for a better understanding of the invention, its operating advantages and the specific objects attained by its uses, references should be had to the accompanied drawings and descriptive matter in which there is illustrated the preferred embodiment of the invention.

### DESCRIPTION OF SEVERAL VIEWS OF THE DRAWING

FIG. 1 is: an isometric view of a parabolic antenna having both part (1) “the main body shield” and part (2) “the receiving eye horn shield” of the present invention attached, thus illustrating no overlap and displays the open space between part (1) and part (2) of the present invention FIG. 1 further illustrates the open space between the reflective side of the main body of the parabolic antenna and the receiving eye horn of the parabolic antenna thus allowing for unimpeded reception of signal.

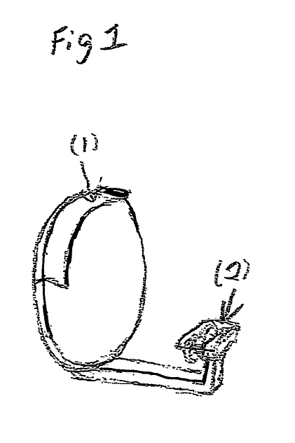

FIG. 2 is: isometric view of the “main body roof/shield” (1) part of the present invention, FIG. 2 further illustrates the C-shaped metal clips (1a) which allow the “main body roof/shield” part (1) of the present invention to clip to the rim of the main body of the parabolic antenna. Which secure the “main body roof/shield” to the rim of the main body of the parabolic antenna.

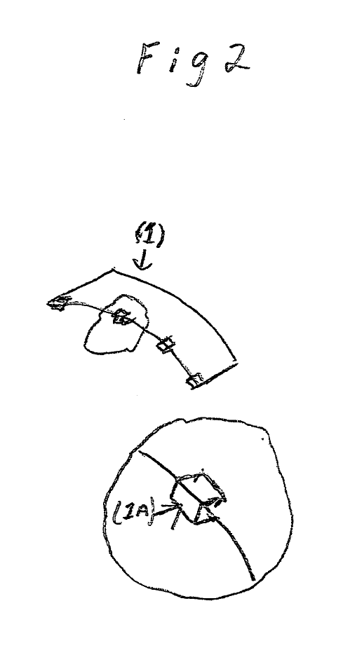

FIG. 3 is an isometric view of the “receiving eye horn roof/shield” part (2) of the present invention, FIG. 3 further illustrates the Velcro strips (2a) which hold the “receiving eye horn roof/shield” part (2) of the present invention to the receiving eye horn of the parabolic antenna, FIG. 3 also illustrates the downward pointing ends (2b) at a ninety degree angle to the top arc of the “receiving eye horn roof/shield” FIG. 3 also illustrates the plastic zip tie (2c) which further assist in attaching part (2) of the present invention to the receiving eye/eyes of the parabolic dish.

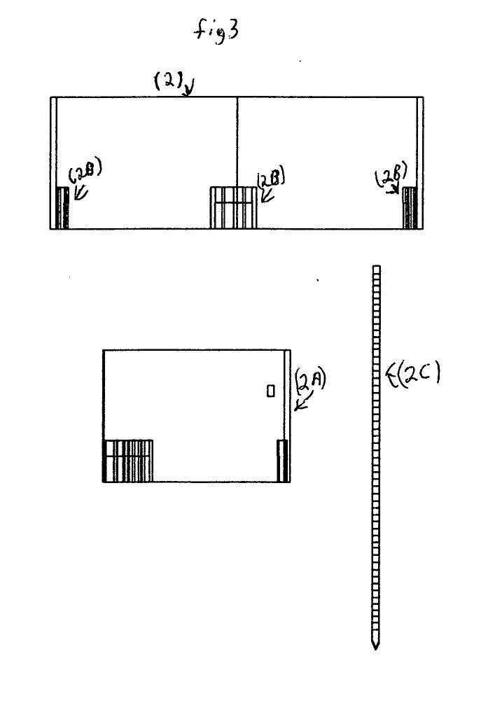

### DETAILED DESCRIPTION OF THE INVENTION

The present invention comprises two parts, the first of two parts being an arc shaped parabolic dish cover approximately 40″×6″×0.020″ (1) constructed of (but not limited to), pliable plastic or poly material having 4 C-shaped metal clips (1a) approximately ½″ wide with the C-shaped metal clips being made with a spring type metal having small metal teeth in opening of the C-shaped metal clips as to secure the clips to the shield and the rim of the parabolic dish being evenly spaced along the long side of the arc thus allowing the roof/shield to clip to the rim of the parabolic dish without altering the dish in any way, as illustrated in the drawings this allows for easy placement or removal of the cover without permanently altering the design or structure of the parabolic antenna. It is further understood the dimensions of the present invention are not limited to those called out in this description. The dimensions can and will change depending on the size and style of parabolic antenna to which it is being attached.

The second part of the present invention is a “receiving eye horn roof/shield” (2) being an arc shaped pliable plastic or polymer, (but not limited to these materials), varying in length being approximately 5″ wide and 0.020″ thick, having two downward sides (2b) being 90 degrees of the arc, as to shield the sides of the receiving eye/eyes from weather with the two sides having ¼″×¼″ square holes in direct proximity of each other to allow for a plastic zip tie, (2c), to be placed thru them and pulled tight to help hold part (2) of the present invention to the receiving eye/eyes of the parabolic antenna, part (2) of the present invention further incorporates 3 adhesive backed Velcro strips (2a) along one side of the arc and the downward sides to further assist in attaching part (2) of the present invention to the receiving eye horn of the parabolic antenna as illustrated in the drawings. This allows for easy placement or removal of the cover without permanently altering the design or structure of the parabolic antenna.

It is therefore an object of the present invention to provide a new improved parabolic satellite dish and receiving eye horn cover that prevents signal lose during bad weather by acting as a roof over the reflective side of the dish or main body of the parabolic antenna, while also acting as a roof over the receiving eye/eyes of the parabolic antenna and in doing so leaving an opening between the two parts of the present invention as illustrated in the drawings. By creating a roof over both the dish and the receiving eye the present invention prevents rain, ice and snow from building up on these parts crucial to the reception of the parabolic antenna while at the same time leaving an opening between roofs/shields allowing an unimpeded signal to be received by the parabolic antenna. This embodies the new and improved features, of the present invention. It is understood that the present invention is not limited to the materials or

It is another object of the present invention to provide a pliable durable construction to be easily and inexpensively manufactured.

It is another object of the present invention to provide a shield/roof (1) extending outward from the concave main body of the parabolic antenna toward the receiving eye horn a short distance thus forming a roof over only the main concave body of the antenna and not the eye horn bracket or the eye horn.

An even further object of the present invention is to form a roof over the receiving eye or eyes (2) extending outward toward the main body of the parabolic antenna but not covering the eye horn bracket nor extending outward far enough to overlap the roof/shield of the main body, thus leaving an opening between the two roofs so that build up on the cover/shields themselves will not diminish signal allowing for an unimpeded reception of the satellite signal. Thus differing from the other covers of known design to the prior art.

It is an even further object of the present invention to prevent rain, snow, and ice from building up on the reflective side of the main body and the receiving eye/eyes of the parabolic antenna. Thus preventing refraction or scrambling of the digital signal allowing for strong undiminished reception.

It is an even further object of the present invention to attach to the main body and the receiving eye/eyes of the parabolic antenna without permanently altering any part of the parabolic antenna, thru the use of the C-shaped metal clips (1a), Velcro strips (2a), and plastic zip tie (2c).

The final object of the present invention is to allow the unimpeded reception of the signal when rain, snow, or ice, is on the roofs/shields thru the ornamental design by incorporating an opening between the two roofs/shields, also by incorporating open space between the reflective side main body and the receiving eye/eyes. Thus differing from the prior art.

### Operation of the Invention

In operating the “Signal Shield Dish Cover” one only need place the main body roof/shield against the rim of the dish making sure the C-shaped clips are clipped over the rim and the shield/roof. Then peel the paper off the back of the adhesive Velcro strips and place the receiving eye roof/shield over the receiving eye horn pressing the Velcro strips against the horn so that they stick then put the zip tie thru the holes made for it in the receiving eye shield and pull tight. Then simply leave the parabolic antenna to its normal operation.

What is claimed is:

1. A method of using a curved arc shield made of (but not limited to), plastic or ploy, over both the reflective dish and the receiving eye of a parabolic antenna, while leaving a large enough opening in the center to allow for the unimpeded reception of the signal, therefore preventing scrambling of the signal being received from the satellite do to ice, snow, or rain, while allowing a clear reception of the signal. Thus being unique to the art.

2. A method of using an arc shaped shield made of (but not limited to), plastic or poly, over both the reflective dish and the receiving eye while leaving a large enough opening in the center for clear reception of the signal whether it is constructed of one piece or two pieces. Therefore being unique to the art.
